(19) United States
(12) Patent Application Publication
(10) Pub. No.: US 2003/0065701 A1
(43) Pub. Date: Apr. 3, 2003

(54) Multi-process web server architecture and method, apparatus and system capable of simultaneously handling both an unlimited number of connections and more than one request at a time

(75) Inventor: Eric R. Uner, Carpentersville, IL (US)

Correspondence Address: Charles F. Meroni, Jr., Meroni & Meroni, Professional Corporation, P.O. Box 309, Barrington, IL, 60011, US

(73) Assignee: Virtual Media, Inc.

(21) Appl. No.: 09/969,385

(22) Filed: Oct. 2, 2001

(51) Int. Cl. G06F 9/00; G06F 15/16

(52) U.S. Cl. 709/102; 709/203

(57) ABSTRACT

This invention provides a multi-process web server architecture, which comprises an Internet connection, a first process connecting to a guest through the Internet connection, and a second group of processes connecting to the first process. This invention also provides a method, which comprises receiving a first request from a client process by a first server process, processing the first request by the first server process to generate a first result, assigning the first request to a second server process based on the first result, the second server process being one of a group of second server processes, receiving the first request by the second server process, processing the first request by the second server process based on a second group of factors to generate a second result, sending the second result directly back to the client process, and receiving the second result by the client process.

### BACKGROUND OF THE INVENTION

1. Field of the Invention

The present invention relates to a web server architecture. More specifically, my invention is primarily intended for providing an improved multi-process web server architecture and method for handling network connections and processing.

2. Description of the Prior Art

Computers and the Internet have become a most significant part of modem communication. Embedded server is getter more and more popular in various industries. Embedded servers are typically designed to work as efficiently as possible with limited resources available. Traditionally, there are two types of architectures that are widely adopted by the data processing industry. One is called single-process architecture, and the other is called multi-process architecture.

The embedded system with single-process architecture serves in-coming requests in the order that they come in. Basically, it is a First-In-First-Out (FIFO) system. A single process listens for requests on the network, processes those requests, sends the processed results to the places according to the instructions along with the requests, and then waits for subsequent requests. The embedded system with single-process architecture can only process one request at a time. It cannot process more than one request at any given time. This feature makes the embedded system with single-process architecture very responsible under the right conditions. Usually, there is no limit to the number of requests an embedded system with single-process architecture can process. However, this architecture has no ability to separate a request demanding short processing time (a small request) from a request demanding long processing time (a big request). Since this architecture only processes requests on a FIFO basis, it might be the case that this architecture will process a big request first, and leave several small requests later. This limits the flexibility of this architecture, and makes it less intelligent than an embedded system with multi-process architecture.

An embedded system with multi-process architecture has a single process (listening process) listening for requests on the network, but hands those requests off to other processes (processing process) to process. This provides the embedded system with multi-process architecture the ability to process more than one requests at a time. The listening process listens for request on the network all the time. As soon as it gets a request from the network, it decides which processing process fits such request, and the availability of that processing process. If the processing process is available, the listening process passes the request to that processing process; if the processing process is not available, the listening process will reject the request, and send it back to the network. Therefore, after the embedded system with multi-process architecture reaches its full processing capacity, additional requests received by the listening process will be sent back to the network by the listening process. The client who generates the request has to re-generate the request and send to the embedded system with multi-process architecture again.

Neither an embedded system with a single-process architecture nor an embedded system with a multi-process architecture is capable of simultaneously handling an unlimited number of connections and more than one request at a time. Various attempts have been made to improve the performance of embedded system and various inventions have been made to provide an architecture capable of simultaneously handling both an unlimited number of connections and more than one request at a time.

U.S. Pat. No. 5,875,302, which issued to Obhan, discloses a Communication Management System Having Communication Thread Structure Including a Plurality of Interconnected Threads. This communication management system and method of operation includes a structure registration interface, a user registration, a submission interface, a communication server and an access interface. The structure registration interface receives structure data and establishes a communication thread structure having a plurality of interconnected threads based upon the structure data. The user registration interface receives user data and establishes user information based upon the user data, the user information linking a user with at least one thread of the plurality of interconnected threads. The submission interface receives communications and at least one desired thread of the plurality of interconnected threads and links the communications with at least some of the plurality of interconnected threads. The communication server establishes links between communications and user information based upon threads of the plurality of interconnected threads. Finally, the access interface receives a communication access request from a user, receives communications from the communication server based upon the communication access request, the user information and thread linkages between the communications and the user information and provides the received communications to the user. The communication management system may also include a notification interface that notifies a user when a communication is received that is linked to the user by at least one thread. The notification interface may notify a user when a communication has been received that is linked to the user by at least one thread and has a notification priority greater than or equal to a notification priority respective to the user. This invention relates generally to the management of communications and more particularly to a system and associated method of operation for receiving multimedia communications, for organizing such communications within structures established solely for organizing the communications, notifying users upon receipt of particular types of communications and the distribution of such communications. However, this invention does not provide us a multi-process web server architecture capable of simultaneously handling both an unlimited number of connections and more than one request at a time.

U.S. Pat. No. 6,147,987, which issued to Chau, et al., discloses a Supporting Load Sharing Across Multiple Network Access Servers. This invention provides a modular architecture for connecting a plurality of telephone lines to a computer network. The invention binds a plurality of network access servers together so that they form a single system image to clients dialing into the plurality of network access servers. The invention operates by providing a tunneling mechanism for communication between the network access servers. The tunneling mechanism facilitates packet re-forwarding so that a call dialed into a physical port in a network access server can be re-forwarded through a logical port in another network access server. This allows a call to be routed through a physical port in a network access server even if no logical port is available in the network access server. Packet re-forwarding also allows multi-link connections through physical ports in multiple network access servers to be routed through a single logical port in a network access server. Packet re-forwarding also provides support for spoofing; if the telephone line is torn down during spoofing, the logical port is maintained so that the connection may be reestablished through a physical port in another network access server. Finally, the present invention supports authentication across multiple network access servers using a security server, by allowing the network access servers to share authentication information. This invention relates to systems for connecting telephone lines to computer networks, and more particularly to an architecture for providing a single system image across multiple network access servers, which connect telephone subscriber lines to a computer network. Although this invention provides an architecture capable of identifying and processing multiple requests at a time, this invention fails to categorize the requests into different groups requesting different length of processing time. Therefore, this invention fails to provide us a multi-process web server architecture capable of simultaneously handling both an unlimited number of connections and more than one request at a time.

U.S. Pat. No. 6,175,879, which issued to Shah, et al., discloses a Method and System for Migrating Connections between Receive-any and Receive-direct Threads. This invention provides a method and mechanism for efficiently handling connections in a computer system between client sockets and data sockets of a server. The server includes a receive-any thread having a socket mask associated therewith to listen for new connection requests and for activity on data sockets handled thereby. The server further includes receive-direct threads associated with at least some of the data sockets for handling data communication. When a receive-direct connection has no activity for a period of time, the connection is migrated to a receive-any connection. When a receive-any connection becomes active, the connection is migrated to a receive-direct connection if a receive-direct thread is available. In a computer system including a client socket connected via a virtual connection with a data socket of a server, a mechanism for handling the connection comprises a receive-direct thread associated with the data socket for handling communication on the connection; a listening thread configured to listen for new connections; a set of socket information associated with the listening thread; means for detecting when the connection has no activity for a period of time; and means for moving information referencing the data socket associated with the receive-direct thread to the set of socket information associated with the listening thread when the connection has no activity for a period of time. This invention also provides a method for handling a connection. This method comprises providing a set of at least one listening thread, each listening thread configured to listen for new connections; providing a set of at least one receive-direct thread; migrating the connection from a first listening thread of the set thereof to a first receive-direct thread of the set thereof when a level of activity is achieved on the connection; and migrating the connection from the first receive-direct thread to one listening thread of the set thereof when a level of inactivity is achieved. Although this present invention provides a method and mechanism for handling a connection in a computer system between a client socket and a data socket of a server, it does not provide an efficient enough method and mechanism for a computer system to handle multiple connections and process multiple requests simultaneously. This invention does not provide a mechanism to determine the time required to process different requests. Neither does this invention provide a mechanism to determine the priority of these requests before the computer system even starts to process those requests. Therefore, this invention fails to provide us a multi-process web server architecture capable of simultaneously handling both an unlimited number of connections and more than one request at a time.

U.S. Pat. No. 6,226,689, which issued to Shah, et al., discloses a Method and Mechanism for Inter-process Communication Using Client and Server Listening Threads. This invention provides a method and mechanism for inter-process communication between a thread of a client application and a thread of a server application. The mechanism includes a server listening thread and a client listening thread. The client thread sends a request to a server listening thread, and the server listening thread places the request in a message queue associated with the server thread. The request is received at the server thread and dispatched to a remote procedure for processing. Reply data received back from the remote procedure is sent to the client listening thread. The client listening thread notifies the client thread when the reply is received and gives the reply to the client thread. Briefly, this invention provides a method and mechanism for inter-process communication including a server thread, a server listening thread associated with the server thread, a client thread and a client listening thread associated with the client thread. The client thread sends a request to the server listening thread, and the server listening thread places a message in a message queue associated with the server thread, preferably by calling the Windows post message API. The message includes the request sent to the server listening thread. The message is received at the server thread, preferably via a Windows message loop. The client request is processed and a reply is sent to the client listening thread. The client listening thread notifies the client thread when the reply is received and gives the reply to the client thread. However, this invention fails to provide us a multi-process web server architecture capable of simultaneously handling both an unlimited number of connections and more than one request at a time.

Although most of these inventions provide a method to somehow enable a system to process multiple requests at same time, none of them is able to provide a multi-process web server architecture that is capable of simultaneously handling both an unlimited number of connections and more than one request at a time. Because of all these problems, what is needed then is a multi-process web server architecture capable of simultaneously handling both an unlimited number of connection sand more than one request at a time.

The current invention is a multi-process web server architecture and a method capable of simultaneously handling both an unlimited number of connection sand more than one request at a time. The multi-process web server architecture of the current invention is an intelligent architecture that is capable of identifying and categorizing various requests into different priority groups and assigning those requests to different processing process to process. The current invention is capable of using static-priority driven scheduling, where tasks with shorter periods get the higher priorities. Therefore, the multi-process web server architecture is able to working as efficiently as possible with all the resources of an enterprise scale computer system.

Accordingly, it is a principal object of my invention to provide a multi-process web server architecture that is capable of real-time performance analysis.

It is a further object of my invention to provide a multi-process web server architecture that is capable of simultaneously handling both an unlimited number of connections and more than one request at a time.

It is a still further object of my invention to provide a multi-process web server architecture that is capable of working as efficiently as possible with all the resources of an enterprise scale computer system.

It is a further object of my invention to provide a method of enabling a web server architecture to execute real-time performance analysis.

It is a still further object of my invention to provide a method of enabling a web server architecture to simultaneously handle both an unlimited number of connections and more than one request at a time.

It is a further object of my invention to provide a method of enabling a web server architecture to work as efficiently as possible with all the resources of an enterprise scale computer system.

### SUMMARY OF THE INVENTION

According to my present invention I have provided a multi-process web server architecture capable of simultaneously handling both an unlimited number of connections and more than one request at a time. This multi-process web server architecture comprises an Internet connection, a first process connecting to a guest through the Internet connection, and a second group of processes connecting to the first process. The guest is either a single guest or a group of guests. The first process is capable of receiving through the Internet connection a request generated by the guest. The first process is capable of categorizing a request from the guest into one of a group of pre-defined categories, the group of pre-defined categories being pre-defined by an administrator of the multi-process web server architecture, the group of pre-defined categories being a single category or a group of categories. The first process is capable of assigning a request generated by the guest to one of the second group of processes. The second group of processes are either a single second process or a group of second processes. The second group of processes are capable of processing a request passed on by the first process, generating a processed result of the request, and sending the processed result of the request back to the first process. The first process is capable of evaluating a request generated by the guest and categorizing the request into one of a group of pre-defined categories, each of the group of pre-defined categories being handled by one of the second group of processes. The first process is capable of deciding which one of the second group of processes to handle a request based on a group of pre-defined factors, the group of pre-defined factors being defined by an administrator of the multi-process web server architecture. The second group of processes further comprises several small group of second processes, each small group of the several small group of second processes capable of handling a request requiring less than a pre-defined length of time, the pre-defined length of time being defined by the administrator of the multi-process web server architecture.

According to my present invention I have also provided another multi-process web server architecture capable of simultaneously handling both an unlimited number of connections and more than one request at a time. This multi-process web server architecture comprises means for connecting, the means for connecting connecting the multi-process web server architecture to a guest, the guest being a single guest or a group of guests, the guest capable of sending a request to the multi-process web server architecture through the means for connecting, means for receiving the request from the guest at the multi-process web server architecture, the means for receiving being associated with and separated from the means for connecting, a first process, the first process connecting to the means for receiving, the first process capable of receiving the request through the means for receiving, the first process capable of determining a time length for processing the request based on a first group of pre-defined factors, the first group of predefined factors being defined by an administrator of the multi-process web server architecture, and a second group of processes connecting to the first process, the second group of processes being a single second process or a group of second processes, the group of second processes being categorized based on a second group of pre-defined factors, the second group of pre-defined factors being defined by the administrator of the multi-process web server architecture, the second group of processes capable of processing the request passed on by the first process, generating a processed result of the request, and sending the processed result of the request back to the guest. The first process is capable of evaluating the request generated by the guest and categorizing the request into one of the group of pre-defined categories, each of the group of pre-defined categories being assigned to one of the second group of processes based on a third group of pre-defined factors, the third group of pre-defined factors being defined by the administrator of the multi-process web server architecture. The first process is capable of deciding which one of the second group of processes to handle the request based on a fourth group of pre-defined factors, the fourth group of pre-defined factors being defined by the administrator of the multi-process web server architecture. The second group of processes further comprises several small group of second processes, each small group of second processes capable of handling the request requiring less than a pre-defined length of time, the pre-defined length of time being defined by the administrator of the multi-process web server architecture.

According to my present invention I have also provided a method of enabling a web server architecture to handle both an unlimited number of connections and more than one request at a time. The method comprises providing a client process, the client process being a single client process or a group of client processes, the client process capable of sending and receiving data, providing a first server process and a second server process, the second server process being a group of second processes having a certain number of second processes, the group of second processes having different second processes with different credentials, the different second processes having a first one of the different second processes and a second one of the different second processes, the different credentials and the certain number of second processes being defined by an administrator of the web server architecture, both the first server process and the second server process capable of receiving, sending and processing data, generating a first request by the client process, sending the first request by the client process to the first server process, receiving the first request by the first sever process, processing the first request by the first server process to generate a first result based on a group of factors, the group of factors being defined by the administrator of the web server architecture, assigning the first request to the first one of the different second processes based on the result, sending the first request to the first one of the different second processes, receiving the first request by the first one of the different second processes, processing the first request by the first one of the different second processes, generating a first processed result by the first one of the different second processes, sending the first processed result directly back to the client process from the first one of the different second processes, and received the first processed result by the client process.

### DESCRIPTION OF THE DRAWINGS

Other features of my invention will become more evident from a consideration of the following detailed description of my patent drawings, as follows:

FIG. 1 is a block diagram representing a computer network into which this present invention may be incorporated;

FIGS. 2 and 3 are a block diagram representing an example with multiples guests and a web server with two Process B;

FIG. 4 is a flow diagram representing the brief operation procedure of this present invention; and

FIG. 5 is a flow diagram representing the operation procedure of this present invention with one requested generated by one guest and a web server with three different second processes.

### DETAILED DESCRIPTION OF THE PREFERRED EMBODIMENT

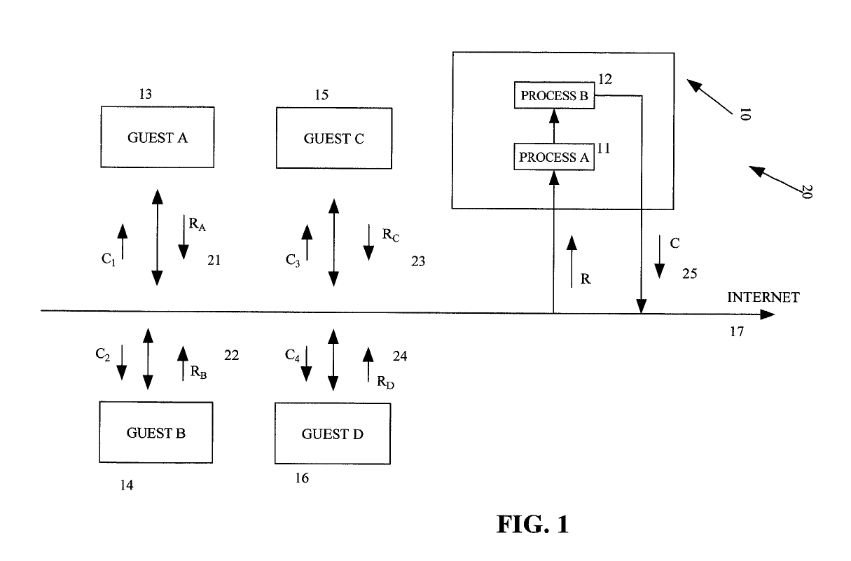

Referring now to FIG. 1, there is shown a computer network 20 generally designated into which the present invention may be incorporated. The computer network 20 comprises a number of guests and a web server 10. These guests can be computers or any computer-based machines, who are able to generate requests and send the requests to the web server 10. The example in FIG. 1 provides fours guests, which are Guest A 13, Guest B 14, Guest C 15 and Guest D 16, and one web server 10. Technically, there is no limitation on the number of guests that can be connected to the network 20. All the guests and the web server 10 are connected to each other through the Internet 17. All the guests and the web server 10 communicate with one another via remote procedure calls by passing data packets. Although in FIG. 1 only one web server 10 is connected to the Internet 17, more than one web server can be connected to the Internet 17 at any given time. In some instances, a web server can be one of the guest to another web server.

The web server 10 in FIG. 1 has at least two processes, Process A 11 and Process B 12. Process A 11 is connected directly to the Internet 17, and is capable of listening requests from the Internet 17. Process A 11 is capable of evaluating the requests and prototype a rough runtime for these requests. Then Process A 11 assigns these requests to different Process B 12 based on different runtime. Process B 12 is capable of processing those requests passed on by Process A 11 and sending the results back to the guests who generate those requests through the Internet 17. Process B 12 usually has more than one parallel processes, each of which handles requests requiring certain run time.

After a request R_{A} 21 is generated by Guest A 13, R_{A} 21 is being sent to the web server 10 through the Internet 17. As soon as Process A 11 in the web server 10 receives R_{A} 21, it starts to process R_{A} 2 based on certain criteria and prototype a runtime for R_{A} 21. Process A 11 then assigns R_{A} 21 to one of the Process B 12, which handles requests with such runtime. Process B 12 then processes R_{A} 21 to generate a result C 25. The result C 25 is then sent back to Guest A 13 via the Internet 17. Practically, it might well be the case that requests R_{B} 22, R_{C} 23 and R_{D} 24 from Guest B 14, Guest C 15 and Guest D 16, respectively, will be processed by the Process A 11 and assigned to one of the Process B 12 before R_{A} 21 is processed by the Process B 12.

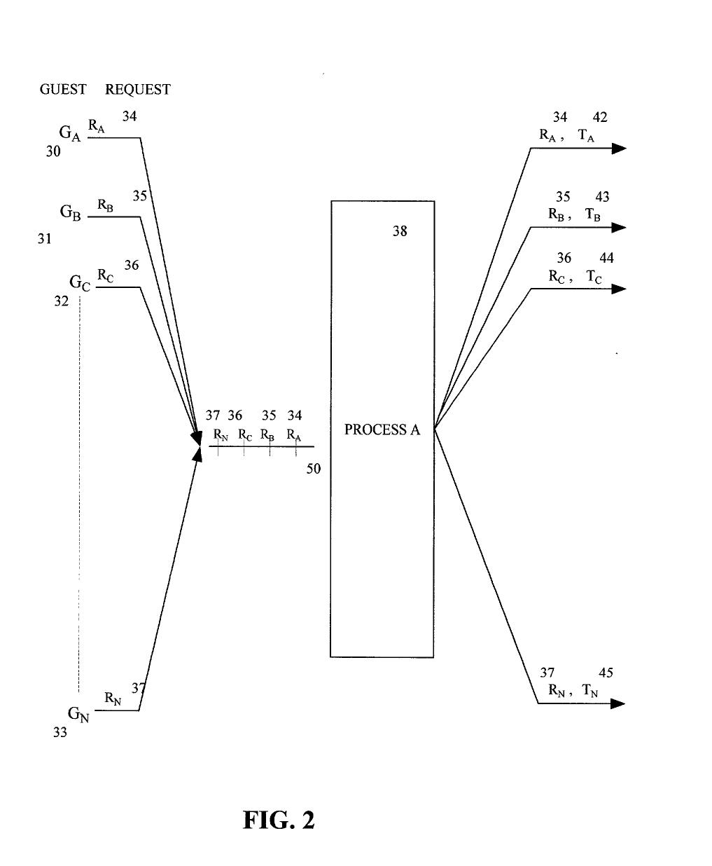

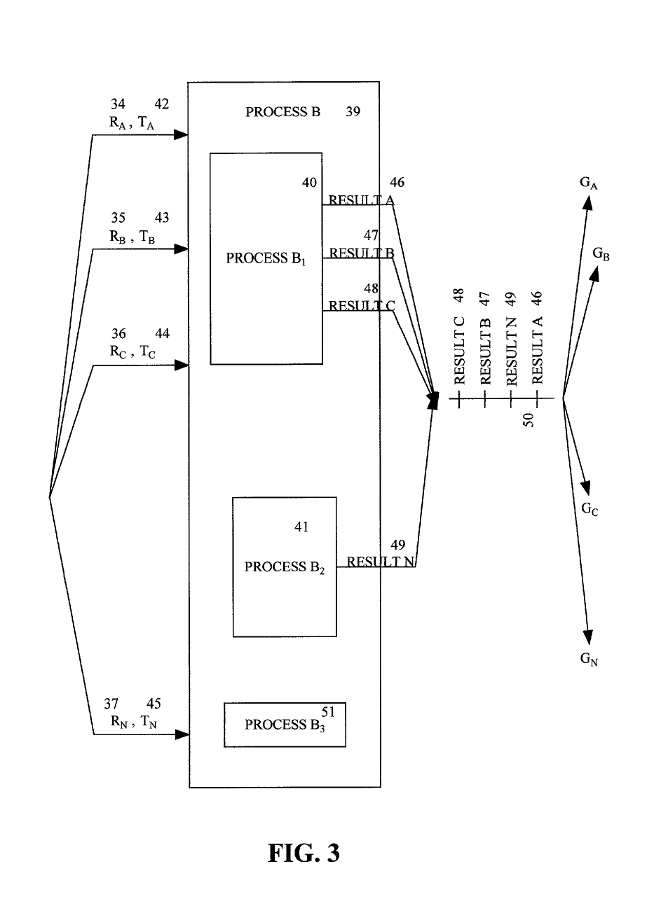

Referring now to FIGS. 2 and 3, there is shown a block diagram of an example of this invention with n guests connecting to a web server with one Process A and two Process B. There are a total of n guests, including G_{A} 30, G_{B} 31, G_{C} 32, . . . and G_{N} 33, connecting to Process A 38 via the Internet. G_{A} 30 generates a request R_{A} 34, and sends the request R_{A} 34 to Process A 38 via the Internet 50; G_{B} 31 generates a request R_{B} 35, and sends the request R_{B} 35 to Process A 38 via the Internet 50; G_{C} 32 generates a request R_{C} 36, and sends the request R_{C} 36 to Process A 38 via the Internet 50; and G_{N} 33 generates a request R_{N} 37, and sends the request R_{N} 37 to Process A 38 via the Internet 50. Therefore, Process A 38 receives R_{A} 34, R_{B} 35, R_{C} 36 and R_{D} 37 in sequence. Process A 38 is pre-programmed to guess a runtime for each request it received. An administrator of the web server 10 is able to configure the web server according to the various needs in order to enable Process A 38 to assign a runtime to various requests and assign requests with different runtime to different Process B 39 according to the configuration made by the administrator of the web server 10. According to the example demonstrated in FIG. 2, Process A 38 processes all the requests and assign runtime T_{A} 42, runtime T_{B} 43, runtime T_{C} 44, . . . and runtime T_{N} 45 to R_{A} 34, R_{B} 35, R_{C} 36 and R_{D} 37, respectively. According to the runtime guideline defined by the administrator of the web server 10, Process A 38 assigns R_{A} _{34, R}_{B} 35 and R_{C} 36 to Process B₁ 40, and R_{D} 37 to Process B₂ 41. Theoretically, there is no limitation to n. The web server 10 is able to handle unlimited number of requests. Before Process B₁ 40 finishes processing the first request it receives, all the other requests received by Process B₁ 40 are stored in the memory of Process B₁ 40. As long as Process B₁ 40 has enough memory, Process B₁ 40 is always ready to receive additional request passed on by Process A 38. In case both Process B1 40 and Process B2 41 run out of memory, additional request is passed to Process B₃ 51, which is a reserved process. Process B₃ 51 will send a notice back to the guest who sent the additional request to inform the guest that the web server is busy, and another request needs to be sent at a later time. The administrator of the web server also has the freedom to configure the Process B₃ 51 according to various needs. One benefit of this invention is that the web server 10 can be configured according to the needs of various situations by the administrator of the web server. The administrator can add a lot of memory onto the Process B 39 to make it virtually impossible to run out of the memory. The administrator can also configure the Process A 38 to define the formula that calculates the runtime. The administrator can also provide the web server 10 with two Process B₃ 51, one of which is reserved to process requests with priorities even when the regular processes are busy. After Process B 39 finishes processing the requests, it generates various results, such as Result A 46, Result B 47, Result C 48 . . . and Result N 49 for G_{A} 30, G_{B} 31, G_{C} 32, . . . and G_{N} 33, respectively. Result A 46, Result B 47, Result C 48 . . . and Result N 49 are then sent back to G_{A} 30, G_{B} 31, G_{C} 32, . . . and G_{N} 33, respectively, via the Internet 50 as soon as they become available.

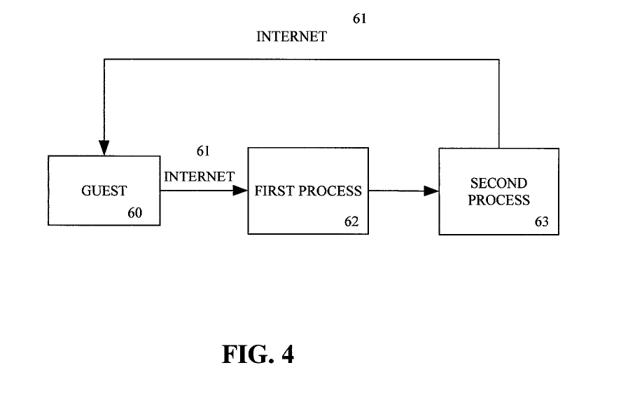

Referring now to FIG. 4, there is shown a flow diagram representing the brief operation procedure of this present invention. This operation procedure needs to have at least one client process which can be executed by a guest 60, a first process 62 and a second process 63. Both the first process 62 and the second process 63 are part of the web server incorporating the present invention. The client process can be a single client process or a group of client processes independently from each other. The client process is capable of sending and receiving data packets over the Internet 61. The first process 62 is a single process, which is capable of evaluate and guess runtime for all the received requests generated by the guest 60. The second process 63 can be a single second process or a group of second processes, each of which has one or a certain number of second processes. Both said first process 62 and said second process 63 are capable of receiving, sending and processing data. The guest 60 generates a request, and send the request to the first process 62 over the Internet 61. The first process 62 then process the request, assign a runtime to the request, and send the request to the second process 63 according to the runtime categorization. Each of the second process 63 handles requests with certain runtime. After processing the request, the second process 63 send the result back to the guest 60 through the Internet 61.

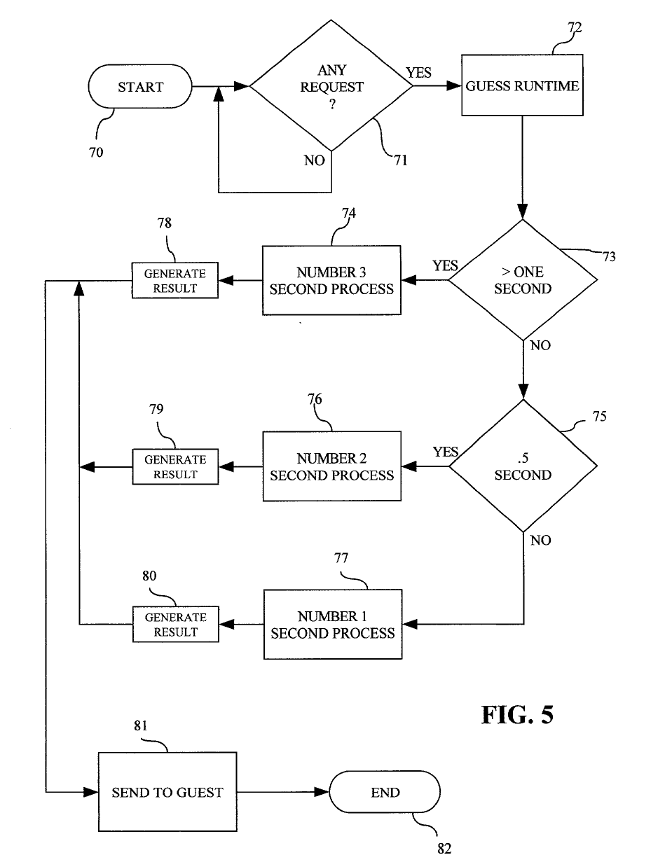

Referring now to FIG. 5, there is shown a flow diagram representing the operation procedure of this present invention with one requested generated by one guest and a web server with three different second processes. A procedure starts at block 70 and proceeds to block 71, where a check is conducted to determine if a request generated by a guest has been received by a first process. If NO, the procedure continues looping awaiting a request generated by a guest. If YES, the procedure proceeds to block 72. At block 72, the first process processes said request based on a group of factors to generate a runtime for the request, and proceeds to block 73. This runtime represents a possible amount of time that a second process needs to take in order to accomplish the request and generate a needed result. The group of factors can be defined by an administrator of the web server architecture. Because the web server might be used for different purposes, and same web server might be assigned for different tasks during different period of time, it is very helpful to have a web server that can be freely configured by the administrator according to the needs at various circumstances. At block 73, a check is conducted to determine if the runtime is more than one second. If YES, the procedure proceeds to block 74. At block 74, the procedure let the first process assign the request to No. 3 of the second process, and proceeds to block 78. At block 78, the procedure let No. 3 of the second process execute the request and generate a result, and proceeds to block 81. Returning to block 73, if NO, the procedure proceeds to block 75, where a check is conducted to determine if the runtime is over half a second. If YES, the procedure proceeds to block 76. At block 76, the procedure let the first process assign the request to No. 2 of the second process, and proceeds to block 79. At block 79, the procedure let No. 2 of the second process execute the request and generate a result, and proceeds to block 81. Returning to block 75, if NO, the procedure proceeds to block 77. At block 77, the procedure let the first process assign the request to No. 1 of the second process, and proceeds to block 80. At block 80, the procedure let No. 1 of the second process execute the request and generate a result, and proceeds to block 81. At block 81, the procedure let the result be sent back to the guest, and proceeds to block 82. At block 82, the procedure ends itself.

Currently, two types of web server architectures are being well adopted by the industry. One is the single-threaded architecture and the other is the multi-threaded architecture. The current invention embodies the benefits of both the single-threaded architecture and the multi-threaded architecture, and is capable of simultaneously handling both an unlimited number of connections and more than one request at a time.

Due to the nature of the Internet itself, it is impossible for Process A 11 in FIG. 1 to receive more than one request from the Internet 17 at any given time. All those requests are divided into small packets and sent to Process A 11 by the guests over the Internet 17. Before Process A 11 is able to execute those requests, all these requests received by Process A 11 are stored at the memory associated with Process A 11. As long as Process A 11 has enough memory, Process A 11 is able to receive unlimited number of requests. The web server 10 works just like a single-threaded architecture. As long as there is enough memory, none of the request will be rejected by the web server.

Referring now to FIG. 2. After Process A 38 has executed a request, a runtime is assigned to that request. Based on the value of the runtime, Process A 38 will assign the request to either Process B₁ 40 or Process B₂ 41. At any given time, both Process B₁ 40 and Process B₂ 41 can only process one request, just like what a multi-threaded architecture can do. However, both Process B₁ 40 and Process B₂ 41 in this invention have its own memory. Process A 38 is able to keep passing on requests with certain runtime to Process B₁ 41 or Process B₂ 41 even though Process B₁ 40 or Process B₂ 41 is still processing a former request. All those waiting-for-process requests will be stored in the memory associated with Process B₁ 40 or Process B₂ 41. Therefore, requests demanding short runtime will not need to wait till a former request with a long runtime being completely executed. This helps the web server 10 work more efficiently than both the single-threaded architecture and the multi-threaded architecture.

Hence, the present invention provides a multi-process web server architecture and a method of enabling a web server architecture to handle both an unlimited number of connections and more than one request at a time.

The present invention also provides a multi-process web server architecture that is capable of real-time performance analysis.

The present invention further provides a multi-process web server architecture that is capable of simultaneously handling both an unlimited number of connections and more than one request at a time.

The present invention still further provides a multi-process web server architecture that is capable of working as efficiently as possible with all the resources of an enterprise scale computer system.

The present invention further provides a method of enabling a web server architecture to execute real-time performance analysis.

The present invention still further provides a method of enabling a web server architecture to simultaneously handle both an unlimited number of connections and more than one request at a time.

The present invention further provides a method of enabling a web server architecture to work as efficiently as possible with all the resources of an enterprise scale computer system.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A multi-process web server architecture capable of simultaneously handling both an unlimited number of connections and more than one request at a time, said multi-process web server architecture comprising:
an Internet connection, said Internet connection connecting said multi-process web server architecture to a guest, said guest being a single guest or a group of guests;
a first process connecting to said Internet connection, said first process capable of receiving through said Internet connection a request generated by said guest, said first process capable of categorizing said request from said guest into one of a group of pre-defined categories, said group of pre-defined categories being pre-defined by an administrator of said multi-process web server architecture, said group of pre-defined categories being a single category or a group of categories; and
a second group of processes connecting to said first process, said second group of processes being a single second process or a group of second processes, said second group of processes capable of processing said request passed on by said first process, generating a processed result of said request, and sending said processed result of said request back to said guest.

2. The multi-process web server architecture in claim 1, wherein said first process is capable of evaluating said request generated by said guest and categorizing said request into one of said group of pre-defined categories, each of said group of pre-defined categories being handled by one of said second group of processes.

3. The multi-process web server architecture in claim 1, wherein said first process is capable of deciding which one of said second group of processes to handle said request based on a group of pre-defined factors.

4. The multi-process web server architecture in claim 1, wherein said group of second processes further comprises several small group of second processes, each of said several small group of second processes capable of handling said request requiring less than a pre-defined length of time, said pre-defined length of time being defined by said administrator of said multi-process web server architecture.

5. A multi-process web server architecture capable of simultaneously handling both an unlimited number of connections and more than one request at a time, said multi-process web server architecture comprising:
an Internet connection;
a first process connecting to a guest through said Internet connection; and
a second group of processes connecting to said first process.

6. The multi-process web server architecture in claim 5, wherein said guest is a single guest or a group of guests.

7. The multi-process web server architecture in claim 5, wherein said first process is capable of receiving through said Internet connection a request generated by said guest.

8. The multi-process web server architecture in claim 5, wherein said first process is capable of categorizing a request from said guest into one of a group of pre-defined categories, said group of pre-defined categories being pre-defined by an administrator of said multi-process web server architecture, said group of pre-defined categories being a single category or a group of categories.

9. The multi-process web server architecture in claim 5, wherein said first process is capable of assigning a request generated by said guest to one of said second group of processes.

10. The multi-process web server architecture in claim 5, wherein said second group of processes are either a single second process or a group of second processes.

11. The multi-process web server architecture in claim 5, wherein said second group of processes are capable of processing a request passed on by said first process, generating a processed result of said request, and sending said processed result of said request back to said first process.

12. The multi-process web server architecture in claim 5, wherein said first process is capable of evaluating a request generated by said guest and categorizing said request into one of a group of pre-defined categories, each of said group of pre-defined categories being handled by one of said second group of processes.

13. The multi-process web server architecture in claim 5, wherein said first process is capable of deciding which one of said second group of processes to handle a request based on a group of pre-defined factors, said group of pre-defined factors being defined by an administrator of said multi-process web server architecture.

14. The multi-process web server architecture in claim 5, wherein said second group of processes further comprises several small group of second processes, each small group of said several small group of second processes capable of handling a request requiring less than a pre-defined length of time, said pre-defined length of time being defined by said administrator of said multi-process web server architecture.

15. A multi-process web server architecture capable of simultaneously handling both an unlimited number of connections and more than one request at a time, said multi-process web server architecture comprising:
means for connecting, said means for connecting connecting said multi-process web server architecture to a guest, said guest being a single guest or a group of guests, said guest capable of sending a request to said multi-process web server architecture through said means for connecting;
means for receiving said request from said guest at said multi-process web server architecture, said means for receiving being associated with and separated from said means for connecting;
a first process, said first process connecting to said means for receiving, said first process capable of receiving said request through said means for receiving, said first process capable of determining a time length for processing said request based on a first group of pre-defined factors, said first group of predefined factors being defined by an administrator of said multi-process web server architecture; and
a second group of processes connecting to said first process, said second group of processes being a single second process or a group of second processes, said group of second processes being categorized based on a second group of pre-defined factors, said second group of pre-defined factors being defined by said administrator of said multi-process web server architecture, said second group of processes capable of processing said request passed on by said first process, generating a processed result of said request, and sending said processed result of said request back to said guest.

16. The multi-process web server architecture in claim 15, wherein said first process is capable of evaluating said request generated by said guest and categorizing said request into one of said group of pre-defined categories, each of said group of pre-defined categories being assigned to one of said second group of processes based on a third group of pre-defined factors, said third group of pre-defined factors being defined by said administrator of said multi-process web server architecture.

17. The multi-process web server architecture in claim 15, wherein said first process is capable of deciding which one of said second group of processes to handle said request based on a fourth group of pre-defined factors, said fourth group of pre-defined factors being defined by said administrator of said multi-process web server architecture.

18. The multi-process web server architecture in claim 15, wherein said second group of processes further comprises several small group of second processes, each small group of second processes capable of handling said request requiring less than a pre-defined length of time, said pre-defined length of time being defined by said administrator of said multi-process web server architecture.

19. A multi-process web server architecture capable of simultaneously handling both an unlimited number of connections and more than one request at a time, said multi-process web server architecture comprising:
means for connecting, said means for connecting connecting said multi-process web server architecture to a guest, said guest capable of sending a request to said multi-process web server architecture through said means for connecting;
means for receiving said request from said guest at said multi-process web server architecture, said means for receiving connecting to said means for connecting;
a first process, said first process connecting to said means for receiving;
a second group of processes, said second group of processes connecting to said first process; and
means for dispatching a processed result of said request from said second group of processes to said guest.

20. The multi-process web server architecture in claim 19, wherein said guest is either a single guest or a group of guests.

21. The multi-process web server architecture in claim 19, wherein said means for receiving is a part of said multi-process web server architecture.

22. The multi-process web server architecture in claim 19, wherein said first process is capable of receiving said request through said means for receiving.

23. The multi-process web server architecture in claim 19, wherein said first process is capable of determining a time length for processing said request based on a first group of pre-defined factors, said first group of pre-defined factors being defined by an administration of said multi-process web server architecture.

24. The multi-process web server architecture in claim 19, wherein said second group of processes is either a single second process or a group of second processes.

25. The multi-process web server architecture in claim 19, wherein said group of second processes is categorized based on a second group of pre-defined factors, said second group of pre-defined factors being defined by said administrator of said multi-process web server architecture.

26. The multi-process web server architecture in claim 19, wherein said second group of processes is capable of processing said request passed on by said first process, generating said processed result of said request, and sending said processed result of said request direct to said guest.

27. The multi-process web server architecture in claim 19, wherein said second group of processes is capable of processing a group of said requests simultanously.

28. The multi-process web server architecture in claim 19, wherein said first process is capable of evaluating said request generated by said guest and categorizing said request into one of a group of pre-defined categories, each of said group of pre-defined categories being assigned to one of said second group of processes based on a third group of pre-defined factors, both said second group of pre-defined factors and said third group of pre-defined factors being defined by said administrator of said multi-process web server architecture.

29. The multi-process web server architecture in claim 19, wherein said first process is capable of deciding which one of said second group of processes to handle said request based on a fourth group of pre-defined factors, said fourth group of pre-defined factors being defined by said administrator of said multi-process web server architecture.

30. The multi-process web server architecture in claim 19, wherein said second group of processes further comprises several small group of second processes, each small group of second processes capable of handling said request requiring less than a pre-defined length of time, said pre-defined length of time being defined by said administrator of said multi-process web server architecture.

31. A multi-process web server architecture capable of simultaneously handling both an unlimited number of connections and more than one request at a time, said multi-process web server architecture comprising:
an Internet connection;
a first process connecting to a guest through said Internet connection, said guest being a single guest or a group of guest; and
a second group of processes connecting to said first process, said second group of processes being a single second process or a group of second processes.

32. The multi-process web server architecture in claim 31, wherein said second group of processes further comprises several small group of second processes, each small group of second processes capable of handling a request from said guest and passed on by said first process requiring less than a pre-defined length of process time, said pre-defined length of process time being defined by an administrator of said multi-process web server architecture.

33. The multi-process web server architecture in claim 32, wherein said second group of processes are capable of processing said request generated by said guest and passed on by said first process, generating a processed result of said request, and sending said processed result of said request directly to said guest.

34. The multi-process web server architecture in claim 33, wherein said first process is capable of receiving through said Internet connection said request generated by said guest.

35. The multi-process web server architecture in claim 34, wherein said first process is capable of categorizing said request from said guest into one of a group of pre-defined categories, said group of pre-defined categories being pre-defined by said administrator of said multi-process web server architecture, said group of pre-defined categories being a single category or a group of categories.

36. The multi-process web server architecture in claim 35, wherein said first process is capable of sending said processed result of said request through said Internet connection back to said guest.

37. The multi-process web server architecture in claim 36, wherein said first process is capable of evaluating said request generated by said guest and categorizing said request into one of a group of pre-defined categories, each of said group of pre-defined categories being handled by one of said second group of processes.

38. The multi-process web server architecture in claim 37, wherein said first process is capable of deciding which one of said second group of processes to handle said request based on a group of pre-defined factors, said group of pre-defined factors being defined by said administrator of said multi-process web server architecture.

39. A multi-process web server architecture capable of simultaneously handling both an unlimited number of connections and more than one request at a time, said multi-process web server architecture comprising:
means for connecting, said means for connecting connecting said multi-process web server architecture to a guest, said guest being a single guest or a group of guests, said guest capable of sending a request to said multi-process web server architecture through said means for connecting;
means for receiving said request from said guest at said multi-process web server architecture, said means for receiving connecting to said means for connecting;
a first process, said first process connecting to said means for receiving;
a second group of processes, said second group of processes connecting to said first process; and
means for dispatching a processed result of said request from said first process to said guest through said means for connecting.

40. The multi-process web server architecture in claim 39, wherein said second group of processes further comprises several small group of second processes, each small group of second processes capable of handling said request requiring less than a pre-defined length of time, said pre-defined length of time being defined by an administrator of said multi-process web server architecture.

41. The multi-process web server architecture in claim 40, wherein said second group of processes is either a single second process or a group of second processes.

42. The multi-process web server architecture in claim 41, wherein said group of second processes is categorized based on a second group of pre-defined factors, said second group of pre-defined factors being defined by said administrator of said multi-process web server architecture.

43. The multi-process web server architecture in claim 42, wherein said second group of processes is capable of processing said request passed on by said first process, generating said processed result of said request, and sending said processed result of said request directly back to said guest.

44. The multi-process web server architecture in claim 43, wherein said first process is capable of receiving said request through said means for receiving.

45. The multi-process web server architecture in claim 44, wherein said first process is capable of determining a time length for processing said request based on a first group of pre-defined factors, said first group of predefined factors being defined by an administration of said multi-process web server architecture.

46. The multi-process web server architecture in claim 45, wherein said first process is capable of evaluating said request generated by said guest and categorizing said request into one of a group of pre-defined categories, each of said group of pre-defined categories being assigned to one of said second group of processes based on a third group of pre-defined factors, both said second group of pre-defined factors and said third group of pre-defined factors being defined by said administrator of said multi-process web server architecture.

47. The multi-process web server architecture in claim 46, wherein said first process is capable of deciding which one of said second group of processes to handle said request based on a fourth group of pre-defined factors, said fourth group of pre-defined factors being defined by said administrator of said multi-process web server architecture.

48. A method of enabling a web server architecture to handle both an unlimited number of connections and more than one request at a time, said method comprising:
providing a client process, said client process being a single client process or a group of client processes, said client process capable of sending and receiving data;
providing a first server process and a second server process, said second server process being a group of second processes having a certain number of second processes, said group of second processes having different second processes with different credentials, said different second processes having a first one of said different second processes and a second one of said different second processes, said different credentials and said certain number of second processes being defined by an administrator of said web server architecture, both said first server process and said second server process capable of receiving, sending and processing data;
generating a first request by said client process;
sending said first request by said client process to said first server process;
receiving said first request by said first sever process;
processing said first request by said first server process to generate a first result based on a group of factors, said group of factors being defined by said administrator of said web server architecture;
assigning said first request to said first one of said different second processes based on said result;
sending said first request to said first one of said different second processes;
receiving said first request by said first one of said different second processes;
processing said first request by said first one of said different second processes;
generating a first processed result by said first one of said different second processes;
sending said first processed result directly back to said client process from said first one of said different second processes; and
received said first processed result by said client process.

49. The method in claim 48, wherein said first sever process is capable of receiving a second request from said client process before said first one of said different second processes finishing processing said first request.

50. The method in claim 48, wherein said first server process is capable of processing a second request from said client process before said first one of said different second processes finishing processing said first request.

51. The method in claim 48, wherein said first sever process is capable of processing a second request to generate a second result based on said group of factors before said first one of said different second processes finishing processing said first request.

52. The method in claim 48, wherein said first sever process is capable of assigning a second request to said second one of said different second processes before said first server process receives said first processed result from said first one of said different second processes.

53. The method in claim 48, wherein said second one of said different second processes is capable of sending a second processed result from said second one of said different second processes directly back to said client process before said first one of said different second processes sends a first processed result directly back to said client process.

54. The method in claim 48, wherein said second one of said different second processes is capable of processing a second request independently from said first one of said different second processes.

55. A method of enabling a web server architecture to handle both an unlimited number of connections and more than one request at a time, said method comprising:
receiving a first request from a client process by a first server process;
processing said first request by said first server process based on a first group of factors to generate a first result;
assigning said first request to a second server process based on said first result, said second server process being one of a group of second server processes;
receiving said first request by said second server process;
processing said first request by said second server process based on a second group of factors to generate a second result;
sending said second result directly back to said client process; and
receiving said second result by said client process.

56. The method in claim 55, wherein said first sever process is capable of receiving a second request from said client process before said client process receives said second result from said second server process.

57. The method in claim 56, wherein said first server process is capable of processing said second request from said client process before said second server process sends said second result directly back to said client process.

58. The method in claim 57, wherein said first sever process is capable of processing a second request to generate a third result based on said first group of factors before said client process receives said second result from said second server process.

59. The method in claim 58, wherein said first sever process is capable of assigning a second request to a third server process before said client process receives said second result from said second server process, said third server process being one of said group of second server processes.

60. The method in claim 59, wherein said client process is capable of receiving a fourth result from said third server process before said client process receives said second result from said second server process.

61. The method in claim 60, wherein said third server process is capable of processing a second request independently from said second server process.

62. An apparatus of enabling a web server architecture to handle both an unlimited number of connections and more than one request at a time, said apparatus comprising:
means for providing a client process, said client process being a single client process or a group of client processes, said client process capable of sending and receiving data;
means for providing a first server process and a second server process, said second server process being a group of second processes having a certain number of second processes, said group of second processes having different second processes with different credentials, said different second processes having a first one of said different second processes and a second one of said different second processes, said different credentials and said certain number of second processes being defined by an administrator of said web server architecture, both said first server process and said second server process capable of receiving, sending and processing data;
means for generating a first request by said client process;
means for sending said first request by said client process to said first server process;
means for receiving said first request by said first sever process;
means for processing said first request by said first server process to generate a first result based on a group of factors, said group of factors being defined by said administrator of said web server architecture;
means for assigning said first request to said first one of said different second processes based on said result;
means for sending said first request to said first one of said different second processes;
means for receiving said first request by said first one of said different second processes;
means for processing said first request by said first one of said different second processes;
means for generating a first processed result by said first one of said different second processes;
means for sending said first processed result directly back to said client process from said first one of said different second processes; and
means for received said first processed result by said client process.

63. The method in claim 62, wherein said first sever process is capable of receiving a second request from said client process before said first one of said different second processes finishing processing said first request.

64. The method in claim 62, wherein said first server process is capable of processing a second request from said client process before said first one of said different second processes finishing processing said first request.

65. The method in claim 62, wherein said first sever process is capable of processing a second request to generate a second result based on said group of factors before said first one of said different second processes finishing processing said first request.

66. The method in claim 62, wherein said first sever process is capable of assigning a second request to said second one of said different second processes before said first server process receives said first processed result from said first one of said different second processes.

67. The method in claim 62, wherein said second one of said different second processes is capable of sending a second processed result from said second one of said different second processes directly back to said client process before said first one of said different second processes sends a first processed result directly back to said client process.

68. The apparatus in claim 62, wherein said second one of said different second processes is capable of processing a second request independently from said first one of said different second processes.

69. An apparatus of enabling a web server architecture to handle both an unlimited number of connections and more than one request at a time, said apparatus comprising:
means for receiving a first request from a client process by a first server process;
means for processing said first request by said first server process based on a first group of factors to generate a first result;
means for assigning said first request to a second server process based on said first result, said second server process being one of a group of second server processes;
means for receiving said first request by said second server process;
means for processing said first request by said second server process based on a second group of factors to generate a second result;
means for sending said second result back to said first server process;
means for receiving said second result by said first server process;
means for sending said second result to said client process; and
means for receiving said second result by said client process.

70. The apparatus in claim 69, wherein said first sever process is capable of receiving a second request from said client process before said client process receives said second result from said second server process.

71. The apparatus in claim 70, wherein said first server process is capable of processing said second request from said client process before said second server process sends said second result directly back to said client process.

72. The apparatus in claim 71, wherein said first sever process is capable of processing a second request to generate a third result based on said first group of factors before said client process receives said second result from said second server process.

73. The apparatus in claim 72, wherein said first sever process is capable of assigning a second request to a third server process before said client process receives said second result from said second server process, said third server process being one of said group of second server processes.

74. The apparatus in claim 73, wherein said client process is capable of receiving a fourth result from said third client before said first server process receives said second result from said second server process.

75. The apparatus in claim 74, wherein said third server process is capable of processing a second request independently from said second server process.

76. The apparatus in claim 75, wherein said apparatus is embedded.

77. An embedded system capable of simultaneously handling both an unlimited number of connections and more than one request at a time, said embedded system comprising:
an Internet connection, said Internet connection connecting said embedded system to a guest, said guest being a single guest or a group of guests;
a first process connecting to said Internet connection, said first process capable of receiving through said Internet connection a request generated by said guest, said first process capable of categorizing said request from said guest into one of a group of pre-defined categories, said group of pre-defined categories being pre-defined by an administrator of embedded system, said group of pre-defined categories being a single category or a group of categories; and
a second group of processes connecting to said first process, said second group of processes being a single second process or a group of second processes, said second group of processes capable of processing said request passed on by said first process, generating a processed result of said request, and sending said processed result of said request back to said guest.

78. The embedded system in claim 77, wherein said first process is capable of evaluating said request generated by said guest and categorizing said request into one of said group of pre-defined categories, each of said group of pre-defined categories being assigned to one of said second group of processes by said first process.

79. The embedded system in claim 77, wherein said first process is capable of deciding which one of said second group of processes to handle said request based on a group of pre-defined factors.

80. The embedded system in claim 77, wherein said group of second processes further comprises several small group of second processes, each of said several small group of second processes capable of handling said request requiring less than a pre-defined length of time, said pre-defined length of time being defined by said administrator of said multi-process web server architecture.
